(19) United States
(12) Patent Application Publication
(10) Pub. No.: US 2013/0179369 A1
(43) Pub. Date: Jul. 11, 2013

(54) STABLE VALUE BIFURCATION SYSTEM & METHOD

(71) Applicant: Bill Templeton, Atlanta, GA (US)

(72) Inventor: Bill Templeton, Atlanta, GA (US)

(21) Appl. No.: 13/738,885

(22) Filed: Jan. 10, 2013

Related U.S. Application Data
(60) Provisional application No. 61/584,902, filed on Jan. 10, 2012.

(51) Int. Cl. G06Q 40/06

(52) U.S. Cl. CPC G06Q 40/06
USPC 705/36 R

(57) ABSTRACT

Systems and methods for financial assets are disclosed. A Stable Value Fund Bifurcation separates the active employee component of the Stable Value Fund from the in-active component to create two funds, each having a different blended rate and duration. This bifurcation for stable value assets is directed to eliminating current structural defects in these funds and to insulate the funds from the potentially cataclysmic effect of interest rates rising and triggering the retiree put.

### CROSS REFERENCE TO RELATED APPLICATIONS

The present application claims the benefit of U.S. application No. 61/584,902, filed Jan. 10, 2012 and titled STABLE VALUE BIFURCATION & SPREAD LOCK ANNUITY SYSTEMS & METHODS, which is herein incorporated by reference in its entirety.

### FIELD OF THE INVENTION

The technology described herein relates generally to financial systems. In particular, the technology described herein relates to stable value assets and annuities.

### BACKGROUND OF THE INVENTION

Stable Value Funds deliver safety and stability by preserving principal and accumulated earnings. They are similar to money market funds but offer considerably higher returns. Their returns make them comparable to intermediate bonds minus the volatility. They are the largest conservative investment in defined contribution retirement plans with over $540 billion in assets.

Stable value funds are capital preservation investment options available in 401(k) plans and other types of savings plans. They are invested in a high quality, diversified fixed income portfolio that are protected against interest rate volatility by contracts from banks and insurance companies. Stable value funds are designed to preserve capital while providing steady, positive returns. Stable value funds are considered a conservative and low risk investment compared to other investments offered in 401(k) plans.

Stable value funds are structured in two ways: as a separately managed account, which is a stable value fund managed for one specific 401(k) plan; or as a commingled fund, which pools together assets from many 401(k) plans. Commingled funds offer the benefits of diversification and economies of scale for smaller plans. Regardless of how stable value funds are structured, they are comprised of a diversified portfolio of fixed income securities that are insulated from interest rate movements by contracts from banks and insurance companies. The protection from interest rate volatility is universal to stable value funds. How this contract protection is delivered depends on the type of stable value fund investment purchased. The contract protection against interest rate volatility is provided through the following investment instruments:
a. A Guaranteed Interest Contract (GIC) is a contract with an insurance company that provides principal preservation and a specified rate of return over a set period of time, regardless of the performance of the underlying invested assets. The invested assets are owned by the insurance company and held within the insurer's general account.
b. A separate account contract is an account held by an insurance company that holds a combination of fixed income securities and provides principal preservation and a specified rate of return over a set period of time. Separate accounts may provide either a fixed rate of return or a periodic rate of return based on the performance of the underlying assets. The assets are owned by the insurance company and are set aside in a separate account solely for the benefit of the specific contract holder.
c. A synthetic GIC is a diversified portfolio of fixed income securities that are insulated from interest rate volatility by contracts (wraps) from banks and insurance companies. In this arrangement, the 401(k) plan and its participants own the underlying invested assets—the portfolio of fixed income securities that support the stable value fund.

The typical stable value fund will diversify contract protection by investing in more than one instrument type and/or with more than one insurance company or bank.

In today's SV (Stable Value) marketplace, the “retiree put” is the largest “fault-line” or “accident waiting to happen” that is embedded within the very structure of the SV asset class.

It is highly undesirable as an employer for your active employees to be subsidizing your retirees. Yet, this is exactly what characterizes virtually 100% of today's SV asset class, where typically half, or more, of the SV assets are attributable to retirees and TVs. Unlike actives, such former employees can withdraw from SV anytime when it's economically attractive to them, with no penalty, and effectively transfer any resultant financial loss onto the remaining actives. This would greatly impair the actives' future SV returns, has uncomfortable fiduciary implications and is the most problematic aspect of today's SV market structure.

Clarification of the “Retiree Put” problem is explained below:
a. Today:
   i. 40%, 50%, 60% or even more of a Stable Value Fund's assets may be attributable to former employees.
   ii. Unlike active employees, i.e. “actives”, such former employees can effectively transfer directly to a competing fund, with no penalty or waiting period, simply by withdrawing from the Plan and transferring to another provider, when the competing fund has a sufficiently higher rate than the Stable Value Credited Rate.
   iii. Losses resulting from such book value withdrawals will be passed on to others: first, to the remaining actives who can't withdraw or transfer directly to a competing fund, and then to the “wrap” issuers once the Credited Rate drops to 0%.
b. Historical Withdrawals:
   i. There have been no such withdrawals for the entire history of Stable Value in its modern form, i.e. for the past 25+ years. All this demonstrates is that people don't exercise out-of-the-money_puts. That is, Stable Value Funds' Credited Rates have been competitive with money market, CD, etc. rates for this entire period, since rates have (in general) been dropping for the entirety of this period.
   ii. Since Stable Value Credited Rates effectively represent the average of preceding years' rates, and since rates have gradually been dropping for this period, there's been no incentive for people to transfer—the outside competing funds' rates have been equal to or lower than the Stable Value credited rate.
   iii. However, what will happen when/if the pattern of rates reverses itself? For the_first time in decades we'll likely begin to see outside rates higher than the Stable Value Credited Rates, such that the “retiree put” will become in-the-money again, also for the first time in decades.
   iv. Actual Examples from the last time this happened:
      1. Massively subsidized rates
      2. Or, massive outflows at the worst time, from those (relatively few) Plans_which (back then) had large percentages of “frictionless” money.
      3. “Death Spiral” (to quote a carrier who experienced this phenomenon before—and who is not in the market currently)
      4. Litigation (US West, etc.)
      5. Damages that (in at least one instance) exceeded actual losses by many_multiples
c. The Future:
   i. Same as before, except much more widespread and severe because now, so many more Plans' Stable Value Funds have so much more former employee money. This is in contrast to the late 1970's and early 1980's, the last time this “put” was meaningfully in-the-money, which was also when most 401(k) plans were being newly created (in stark contrast to today, when most DC plans are mature).
   ii. Because today's interest rates are so low, it would not take much of an increase—by historic standards—to trigger this, particularly if the rate increases were to unfold at speed (i.e. like most of the financial upheavals of the past few decades).
   iii. Consequences:
      1. loss of existing business (both the retiree's withdrawals, plus the unhappy Plan sponsors which result from the losses those withdrawals realize)
      2. new entrants will artificially appear ultra-competitive since they'll have no_“old money” dragging down returns
      3. massive losses once the Credited Rate hits 0%, in an environment of higher (and likely increasing) interest rates
      4. embarrassing litigation
      5. embarrassing public relations (Facebook, etc.)

Today's Other “Solutions”

| Other “Solution” | Negative |
|---|---|
| shorten greatly | fights the yield curve, hurts |
| | actives' returns needlessly |
| go “wrap-less” | now it's just another bond fund |
| (open or closed-end) | (either way) |
| separate inactive-only fund, | takes rate from Participant A |
| allocate shortest maturities | and gives it to Participant B |
| separate inactive-only fund, | greatly increases risk of Credited |
| allocate pro-rata so each | Rate dropping below 0% |
| participant gets his/her full | |
| fair share of the portfolio | |
| prior to separation | |
| separate inactive-only fund, | requires liquidating the entire portfolio |
| with each group getting its | |
| full fair share of the portfolio | |
| prior to separation | |

Stable Value “Bifurcation” avoids all the above, but removes the “retiree put” and immediately begins to reduce risk, including litigation risk.

The need exists for a solution that addresses this situation.

The foregoing information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to financial systems and methods.

The purpose of this “Bifurcation” process is to eliminate this structural defect. The potential market (i.e. the sum of SV monies in today's US market) is over $200 billion.

In the following example a SV fund of $3 billion is used, with a 3% blended rate and a 3 year assumed duration.
a. Step 1: A bifurcation line divides an inactive portion from an active portion. The bifurcation line demarks the one SV fund between these segments—both segments continue to receive the same rate and outflow methodology as before the creation of the bifurcation. Both active and in-active portions receive the same blended rate until Step 2, at which point both portions gradually begin to receive separate rates, very slightly different at first but gradually becoming more and more different as the Bifurcation unfolds.
b. Step Two, begins as SV monies mature. The “Old” SV Fund remains the same as in Step 1, except it now receives no new inflows and pays no outflows until the respective Step 2 piece is exhausted. Assuming, as an example, that $1 billion has matured. Both portions continue to receive the same rate, but the “old” SV fund now has only $2 billion (50/50 in-active/active) and a 2 year remaining duration. This process is invisible to participants, except that the actives and in-actives begin to receive a slightly different blended rate. None of the above is a competing or “new” fund that the participants see, rather, all that's happening is:
   i. the gradual, invisible separation of the In-actives' accounts from the Actives' accounts within SV, with
   ii. no material change in the outflow experience of the existing “wrapper” providers. The old SV is not simply “cloned” between the actives and in-actives, since that would, in contrast to the above methodology, remove the “buffer” of the actives' rate above 0%. But it begins the actual separation, preserving the existing wrappers' short-term risk profile via LIFO provisions for each new “bifurcated” portion even while greatly improving the existing “wrappers” long-term risk profile, by gradually eliminating the In-actives' Put.
   iii. Step 3: The “Old” SV is the same as before except now it is down to $1 billion and 1 year remaining Maturities have gone into the new Bifurcated piece. All the above is invisible to participants, except that the actives and in-actives to receive an increasingly different blended rate.
   iv. Step 4: The “Old” SV fund is gone, everything has matured. The New Bifurcated Inactive and Active SV is comprised of:
      i. Retiree Fund
         1. Receives
         a. Automatic transfer upon termination
         b. Transfers in by retirees from equity
         c. Loan repayment by retirees if applicable
         2. Pays
         a. All outflows/transfers attributable to In-actives
         3. Duration
         a. Very Short
         4. Blended Rate: For In-actives
      ii. Active's Fund
         1. Receives:
         a. All transfers to SV attributable to Actives
         b. All contributions to SV by Actives
         2. All loan repayments to SV by Actives
         3. Pays:
         a. All outflows/transfers attributable to Actives
         b. Automatic transfer to Retiree SV Fund upon termination
         4. Duration
         a. Short/intermediate (can be longer due to longer liability, now that there is no “put”
         5. Blended Rate: For Actives

The SV Bifurcation is a vital structural repair in the architecture of the entire Stable Value asset class, which exceeds $200 billion and may well exceed $300 billion. It accomplishes this by combining:
a. a change in business process—specifically, separating the active employee component of the Stable Value Fund from the in-active (TV and retiree) component to create two funds where now there's one (with a big built-in flaw) with
b. a new blended rate innovation, which to actuate depends upon a new computer-driven blended rate process which adds a new level of complication to the existing computerized blended rate calculations by introducing the concept of a “shared” fund within the overall Stable Value fund that's
c. not separately visible to participants and which
d. continuously changes in proportionate allocation with respect to the two separating SV components which are distinctly visible to participants.

When the SV Bifurcation methodology is applied to virtually any Stable Value fund in today's market, the effect is to hugely insulate that fund from the potentially cataclysmic effect of interest rates rising and triggering the “retiree put.” The best analogue is re-engineering a large building in an earthquake zone to enable it to weather seismic shifts, which from the perspective of SV can be predicted to occur if interest rates in the marketplace rise quickly and substantially (i.e., as they have done in the past, but not within the past 25 years). The funds to which SV Bifurcation would apply are not registered securities nor mutual funds, although they are often offered by mutual fund companies for limited clients: specifically, participants in qualified 401(k) or other qualified defined contribution plan. Group annuity contracts are often the vehicle by which Stable Value is delivered, and such contracts are issued by insurance companies and not subject to SEC oversight. In short, rather than a security or business process, the SV bifurcation invention is a conceptual innovation which greatly enhances the structural integrity of any Stable Value fund that uses it, because it immediately reduces and eventually eliminates the “retiree put” and the extremely adverse impact that “put” would have on the remaining SV assets, were that put to be exercised as expected.

Simply separating the SV fund into its active and in-active components would represent a simple change in business process, but unlike SV Bifurcation that has major downsides which SV Bifurcation does not:
a. simply splitting would increase the “wrap” issuers' near-term risk of withdrawals producing a 0% return, if the fund is split uniformly, but
b. if split non-uniformly such as allocating the shortest paper to the retirees, would effectively take yield from one group and give it to another. By virtue of its unique conceptual innovations of a “two-tiered” computer-driven blended rate process, SV Bifurcation invention avoids both problems, which up to now (i.e. before SV Bifurcation) have been intractable.

Important Computer Aspect: Stable Value funds are inherently more complicated than all other 401(k) or other DC funds, since they require that two sets of books be maintained and perpetually reconciled. Virtually all stable value funds simultaneously have:
a. an underlying portfolio of securities carried at market value and
b. a book value fund equal to the sum of the participant accounts. The withdrawals and transfers from the Plan by all participants are determined by the book value account. Differences between the book value account and the market value account are amortized via the interest rate credited the SV fund. All of today's SV funds require extensive computer support because of the huge number of data points needed to be tracked and aggregated: each participant account, each security's market value, the “wrap” blended rate which amortizes the difference between book and market value and the amount of interest to be credited to each participant's account as per that blended rate.

The SV Bifurcation idea requires multiplication of the computer-dependent complexity already characteristic of SV funds, because:
a. Bifurcation creates three funds where only one exists today;
b. these three funds must be appropriately allocated between all SV participants each valuation date (i.e. monthly or possibly more often);
c. the proportions by which each of the three SV funds bear to each other changes continuously as underlying securities mature and participant withdrawals, transfers and contributions occur and finally
d. two of the three SV funds created by Bifurcation are permanent, but one is temporary and shared by the other two SV funds as it gradually diminishes.

In short, SV Bifurcation takes what's already a highly dependent on computer support and multiplies that by creating three funds where currently there's only one, and all of these three funds have three parts (book value, market value and “wrap” contract). Moreover SV Bifurcation doubles the blended rate calculation among these funds by creating a third, “shared” SV fund that's not distinctly visible to participants. Rather, it's shared between the two “visible” SV funds (the actives' SV fund and the in-actives' SV fund).

In summary, the figures illustrate graphically how the SV Bifurcation innovation operates over time, whereby the existing one-fund structure is gradually separated into two without:
a. any increase in near-term risk to “wrap” issuers, which is what would occur if the SV fund were simply split proportionately and
b. without any hint of misallocating some participants' returns to other participants, which is exactly what would happen if the SV fund were simply split by duration (longer paper to actives, shorter paper to in-actives). However, in order to achieve these appropriate objectives, the SV Bifurcation innovation requires more sophisticated computer-driven blended rate calculations and participant activity tracking than currently applies in SV.

At its essence, all the above constitutes an improvement in the “structural engineering” of the Stable Value asset class by a process that's both:
a. complicated (because it requires a whole new concept and computer-driven step in calculating an SV blended rate) but
b. natural (because it accomplishes this structural repair in tandem with the underlying cash flows and involves no uncomfortable aspect of favoring one group of participants over the other). Indeed, the entire purpose of this SV Bifurcation invention is to preclude the structural favoritism that currently exists.

The SV Bifurcation innovation removes this implicit subsidy and in particular removes the pernicious effects which the current structure can be predicted to produce, when CD and similar interest rates available in the marketplace increase above SV credited rates. The overall purpose and effect of the idea is to buttress the “Stable” in “Stable Value” by preserving the competitive nature of the SV blended rate, regardless of rate increases or decreases.

As a result:
a. participants get what they expect,
b. no longer can participants subsidize (or exploit) other participants within the SV fund,
c. plan sponsors and their advisors avoid ugly surprises when rates go the wrong way, after 2.5 decades

Optional Feature—ECRO (Enhanced Credited Rate Option): to reiterate, the SV Bifurcation system is vital to the structural integrity of the SV asset class since it repairs its most glaring structural flaw: the risk of the SV Credited Rate becoming deeply uncompetitive—even potentially down to 0%—in the event of a rate increase and subsequent exercise of the “retiree put.”

Another related mechanism which works toward the same end, and can be especially useful in plan where in addition to the implicit ‘retiree put” there's also “put” aspects within the active participants in the form of after-tax monies or other potentially Credited Rate disrupting elements. This secondary rate stabilization mechanism involves using a new and sophisticated Credited Rate amortization formula as follows: Credited Rate=Current Yield plus [(MV−BV) divided by (MV×2D)].

Under currently prevailing SV amortization formulas, if the MV is 95% of BV and the portfolio's yield to maturity is 5.0% and its duration 3 years, the Credited Rate is around 3.25%. This reflects the credited rate on the SV book value at which it will converge with the market value over the duration of the portfolio. The downside is that this convergence depends upon there being no withdrawals, which is unrealistic if the Credited Rate is uncompetitive—3.25% versus prevailing market rates of 5.0%.

But if one uses the above proprietary Credited Rate formula, then that forces an asymmetrical pattern of amortization, which, especially when coupled with SV Bifurcation, helps “force” the Credited Rate from getting too out of whack with prevailing rates, thus also helping to avoid the self-fulfilling prophecy of a “death spiral.” In the above example the first year CR would be 4.12% instead of 3.25%.

Thus, when coupled with SV Bifurcation the structural integrity of the SV asset class is greatly improved in that it's uncomfortable “put” aspects where one group of participants effectively subsidizes another are either removed entirely (as in SV Bifurcation) or mitigated by the Enhanced Credited Rate Option (ECRO) described later in this document.

Advantages of SV Bifurcation are:
a. It immediately begins to reduce risk of “retiree put”;
b. It provides immediate “lawsuit inoculation” when presented to client;
c. In a short time, it eliminates the “retiree put” risk completely;
d. It increases capacity for better SV business;
e. It increases profitability;
f. It avoids risk to reputation;
g. Higher credited rates for SV participants (especially actives);
h. Risk of “Death Spiral” is effectively eliminated, if Bifurcation is implemented sufficiently before outside rates exceed the Credited Rate
i. The “Window of Opportunity” is now, while interest rates are still low;
j. It benefits all Stable Value Stakeholders

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 illustrates step 1 in the SV Bifurcation process, according to an embodiment of the technology described herein;

FIG. 2 illustrates step 2 in the SV Bifurcation process, according to an embodiment of the technology described herein;

FIG. 3 illustrates step 3 in the SV Bifurcation process, according to an embodiment of the technology described herein; and

FIG. 4 illustrates step 4 in the SV Bifurcation process showing the Old SV fund 100 empty (designated by the “x” inside the oval), everything matured, and showing the new Bifurcated In-Active and Active SV according to an embodiment of the technology described herein.

### DETAILED DESCRIPTION OF THE INVENTION

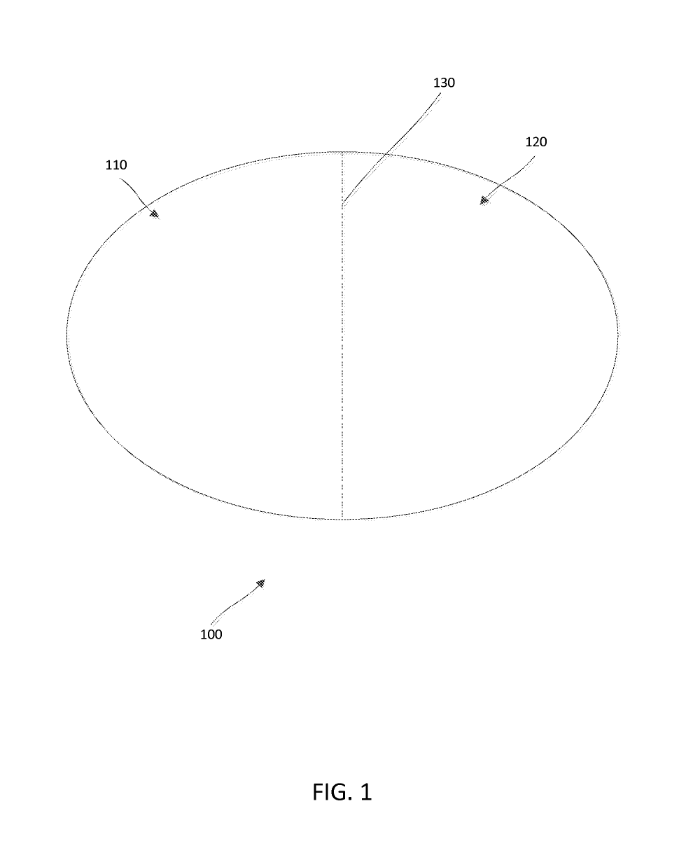

In describing the preferred and other embodiments of the technology described herein, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

In an exemplary embodiment of the technology described herein, referring to FIGS. 1-4, an SV Fund 100 is illustrated. In this example, a $3 billion dollar fund is illustrated, with a 3% assumed blended rate and a 3 year assumed duration. During year 1 both the retired (inactives) and the currently employed (actives) participants received the same rate and outflow methodology. A bifurcation line 130 demarks the SV Fund 100 between these two segments, creating an inactive portion 110 and an active portion 120.

Referring now to FIG. 1, both the active portion 120 and the in-active portion 110 receive the same blended rate until bifurcation step 2, at which point both portions gradually begin to receive separate rates, very slightly different at first, but gradually becoming more and more different as the Bifurcation process unfolds.

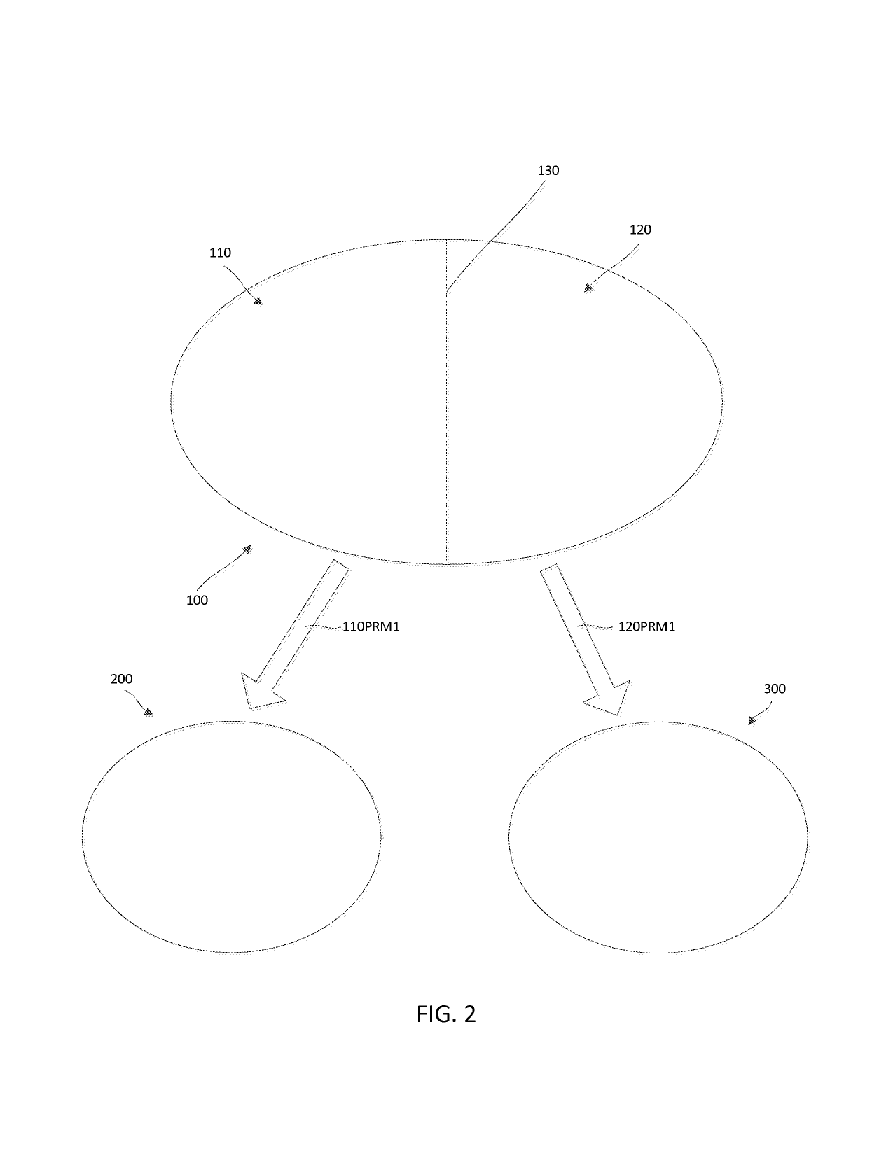

Referring now to FIG. 2, Bifurcation—Step Two begins as SV monies mature. The “Old” SV Fund remains the same as in step 1 except that it receives no new inflows and pays no outflows until the respective Step 2 piece is exhausted. For example, assume $1 billion has matured. Inactive pro rata maturities 110PRM1 create bifurcated inactive SV portion 200 (in this example $500 million). Active pro rata maturities 120PRM1 create bifurcated active SV portion 300 (in this example $500 million).

Both SV portions (inactive portion 110 and active portion 120) continue to receive the same rate, but the “old” SV fund 100 now has only $2 billion (50/50 in-active/active) and a 2 year remaining duration. All the above is invisible to participants, except that the actives and in-actives begin to receive a slightly different blended rate.

None of the above is a competing or “new” fund that the participants see, rather, all that's happening is:
a. the gradual, invisible separation of the In-actives' accounts from the Actives' accounts within the SV, with
b. no material change in the outflow experience of the existing “wrapper” providers. The old SV is not simply “cloned” between the actives and in-actives, since that would, in contrast to the above methodology, remove the “buffer” of the actives' rate above 0%. But it begins the actual separation, preserving the existing wrappers' short-term risk profile via LIFO provisions for each new “bifurcated” portion even while greatly improving the existing “wrappers” long-term risk profile, by gradually eliminating the In-actives' Put.

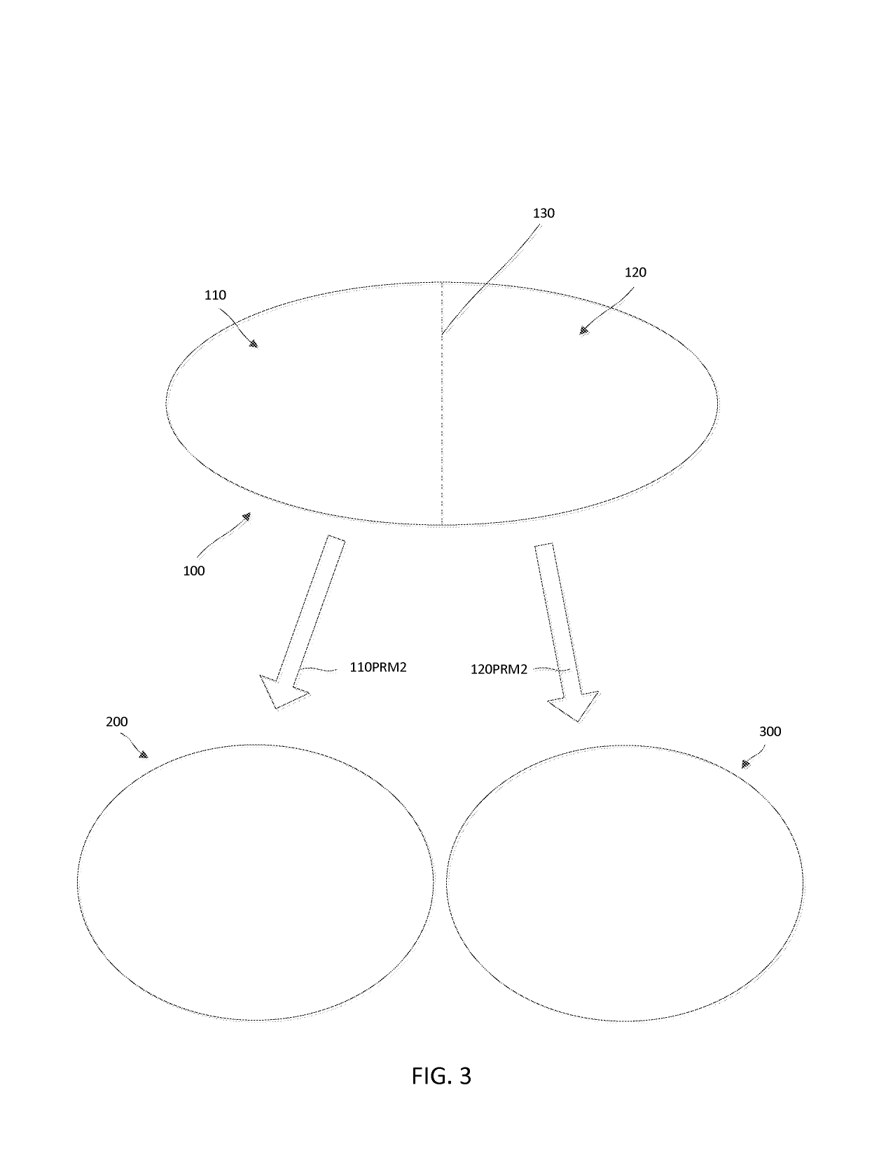

SV Bifurcation—3^{rd} step: referring now to FIG. 3, the “Old” SV fund 100 remains the same as before except it is now down to $1 billion with 1 year remaining Maturities have gone into the new Bifurcated pieces, e.g. inactive pro rata maturities 110PRM2 go into bifurcated inactive SV portion 200 (in this example resulting in $1 billion) and inactive pro rata maturities 120PRM2 go into bifurcated inactive SV portion 300 (in this example resulting in $1 billion). All the above is invisible to participants, except that the actives and in-actives to receive an increasingly different blended rate.

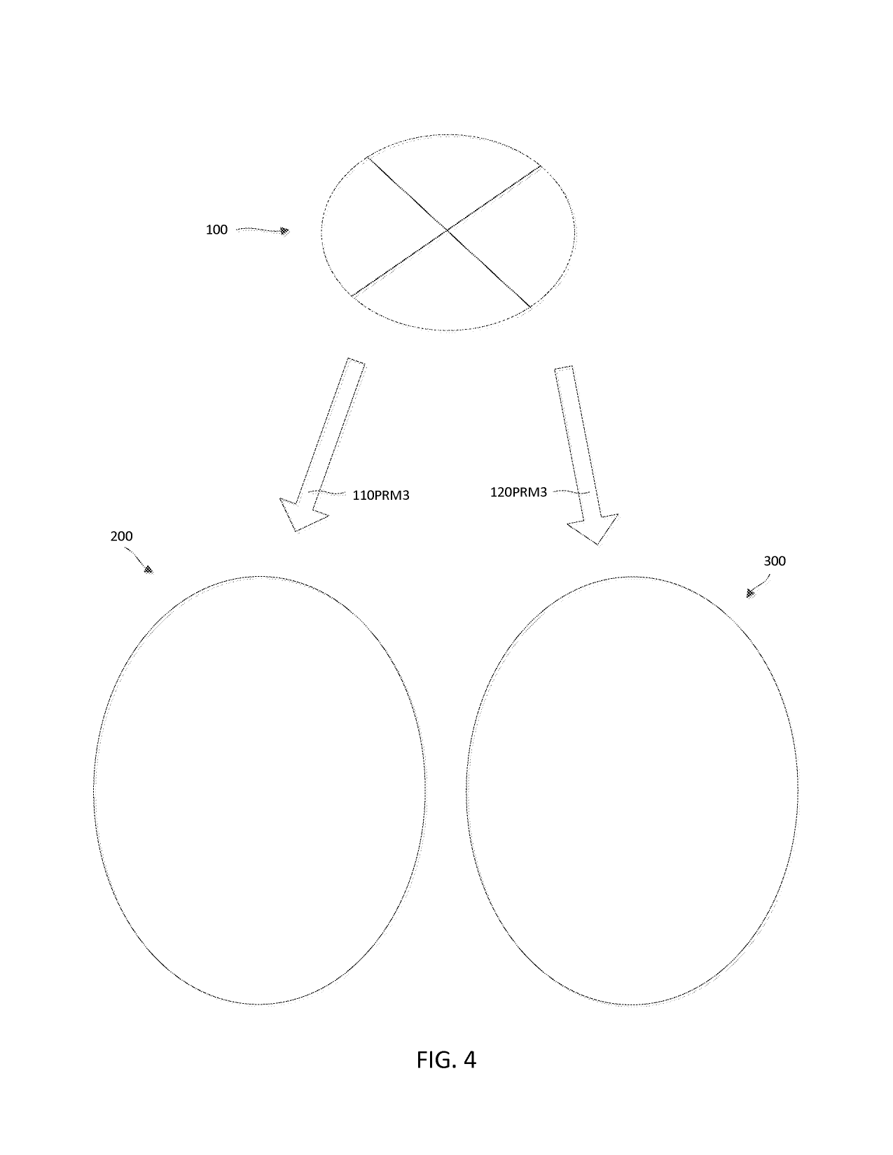

SV Bifurcation—Final Step: referring now to FIG. 4, the “Old” SV fund 100 is exhausted—everything has matured. Inactive pro rata maturities 110PRM3 flowed into bifurcated in-active SV portion 200, and Active pro rata maturities 120PRM3 flowed into bifurcated active SV portion 300.

The bifurcated in-active SV portion 200 (Retiree Fund) has the following characteristics:
a. Receives:
   i. Automatic transfer upon termination
   ii. Transfers in by retirees from equity
   iii. Loan repayments by retirees if applicable
b. Pays:
   i. All outflows/transfers attributable to in-actives
c. Duration:
   i. Shorter than Actives
d. Blended Rate:
   i. In-actives' Blended Rate

The bifurcated active SV portion 300 (Active's Fund) has the following characteristics:
a. Receives:
   i. All transfers to SV attributable to Actives
   ii. All contributions to SV by Actives
   iii. All loan repayments to SV by Actives
b. Pays:
   i. All outflows/transfers attributable to Actives
   ii. Automatic transfer to Retiree SV Fund upon termination
c. Duration:
   i. Short/intermediate (can be longer due to longer liability, now that there is no “put”
d. Blended Rate:
   i. Actives' Blended Rate

The SV Bifurcation is neither an Investment nor a mere Business Process. Rather, it is a vital structural repair in the architecture of the entire Stable Value asset class, which exceeds $200 billion and may well exceed $300 billion. It accomplishes this by combining:
a. a change in business process—specifically, separating the active employee component of the Stable Value Fund from the in-active (TV and retiree) component to create two funds where now there's one (with a big built-in flaw) with
b. a new blended rate innovation, which to actuate depends upon a new computer-driven blended rate process which adds a new level of complication to the existing computerized blended rate calculations by introducing the concept of a “shared” fund within the overall Stable Value fund that's
c. not separately visible to participants and which
d. continuously changes in proportionate allocation with respect to the two separating SV components which are distinctly visible to participants.

When the SV Bifurcation invention is applied to virtually any Stable Value fund in today's market, the effect is to hugely insulate that fund from the potentially cataclysmic effect of interest rates rising and triggering the “retiree put.” The best analogue is re-engineering a large building in an earthquake zone to enable it to weather seismic shifts, which from the perspective of SV can be predicted to occur if interest rates in the marketplace rise quickly and substantially (i.e., as they have done in the past, but not within the past 25 years). The funds to which SV Bifurcation would apply are not registered securities nor mutual funds, although they are often offered by mutual fund companies for limited clients: specifically, participants in qualified 401(k) or other qualified defined contribution plan. Group annuity contracts are often the vehicle by which Stable Value is delivered, and such contracts are issued by insurance companies and not subject to SEC oversight. In short, rather than a security or business process, the SV bifurcation invention is a conceptual innovation which greatly enhances the structural integrity of any Stable Value fund that uses it, because it immediately reduces and eventually eliminates the “retiree put” and the extremely adverse impact that “put” would have on the remaining SV assets, were that put to be exercised as expected.

Simply separating the SV fund into its active and in-active components would represent a simple change in business process, but unlike SV Bifurcation that has major downsides which SV Bifurcation does not: (a) simply splitting would increase the “wrap” issuers' near-term risk of withdrawals producing a 0% return, if the fund is split uniformly, but (b) if split non-uniformly such as allocating the shortest paper to the retirees, would effectively take yield from one group and give it to another. By virtue of its unique conceptual innovations of a “two-tiered” computer-driven blended rate process, SV Bifurcation invention avoids both problems, which up to now (i.e. before SV Bifurcation) have been intractable.

Important Computer Aspect: Stable Value funds are inherently more complicated than all other 401(k) or other DC funds, since they require that two sets of books be maintained and perpetually reconciled. Virtually all stable value funds simultaneously have:
a. an underlying portfolio of securities carried at market value and
b. a book value fund equal to the sum of the participant accounts.

The withdrawals and transfers from the Plan by all participants are determined by the book value account. Differences between the book value account and the market value account are amortized via the interest rate credited the SV fund. All of today's SV funds require extensive computer support because of the huge number of data points needed to be tracked and aggregated: each participant account, each security's market value, the “wrap” blended rate which amortizes the difference between book and market value and the amount of interest to be credited to each participant's account as per that blended rate.

The SV Bifurcation idea requires multiplication of the computer-dependent complexity already characteristic of SV funds, because (a) Bifurcation creates three funds where only one exists today; (b) these three funds must be appropriately allocated between all SV participants each valuation date (i.e. monthly or possibly more often); (c) the proportions by which each of the three SV funds bear to each other changes continuously as underlying securities mature and participant withdrawals, transfers and contributions occur and finally (d) two of the three SV funds created by Bifurcation are permanent, but one is temporary and shared by the other two SV funds as it gradually diminishes.

In short, SV Bifurcation takes what's already a highly dependent on computer support and multiplies that by creating three funds where currently there's only one, and all of these three funds have three parts (book value, market value and “wrap” contract). Moreover SV Bifurcation doubles the blended rate calculation among these funds by creating a third, “shared” SV fund that's not distinctly visible to participants. Rather, it's shared between the two “visible” SV funds (the actives' SV fund and the in-actives' SV fund).

In summary, FIGS. 1-4 illustrate graphically how the SV Bifurcation methodology operates over time, whereby the existing one-fund structure is gradually separated into two without:
a. any increase in near-term risk to “wrap” issuers, which is what would occur if the SV fund were simply split proportionately and
b. without any hint of misallocating some participants' returns to other participants, which is exactly what would happen if the SV fund were simply split by duration (longer paper to actives, shorter paper to in-actives). However, in order to achieve these appropriate objectives, the SV Bifurcation innovation requires more sophisticated computer-driven blended rate calculations and participant activity tracking than currently applies in SV.

Commercial Opportunities: There are two primary commercial objectives which the SV Bifurcation invention satisfies as perfectly as they can be satisfied:

1^{st}, the actual stability of the SV fund would be vastly improved if the SV Bifurcation invention is adopted, since the single greatest source of potential instability—the “retiree put”—is neutralized. If the fee for use of the idea is 2 basis points per year and the SV market is $200 billion, then that produces $40 million in potential annual revenue (not an absurd proposition given that the “dollar window” idea came to dominate the SV “window” GIC market in the mid-to-late 1980's within only a year or two of its creation). Even if limited to one SV provider—Metropolitan for example—which has $35 billion of SV assets, this Bifurcation fee would still be hugely substantial from a small business perspective (i.e. $7 million per year)

2^{nd}, even if not a single dollar of SV monies adopts the SV Bifurcation solution to the problem of the “retiree put,” there's still massive value potential in that (a) the SV Bifurcation idea is eminently sound and reasonable and indeed better matches assets with liabilities than the existent SV structures, and (b) as such represents a perfect way for SV providers to inoculate themselves from litigation risk, in the highly likely event that without repair the “put” will eventually be exercised when (for the first time in decades) it becomes “in the money” and as such will trigger the same sort of litigation that unfolded the last the this “put” became attractive. By presenting the SV Bifurcation idea to its clients an SV provider like Metropolitan could nicely insulate itself from future litigation risk, since any unraveling of the SV fund as a result of the retiree put being exercised would now be the Plan Sponsor's fault, for not accepting the Bifurcation solution proposed by the SV provider. For example, for a one-time fee of $25,000 per Plan which rejects the Bifurcation idea, if there are 500 such clients the fee is $12.5 million. (Such one-time per-plan fee would be paid by the SV provider, which is the one who benefits from the litigation inoculation provided by the Plan Sponsor's rejection of the Bifurcation solution).

At its essence, all the above constitutes an improvement in the “structural engineering” of the Stable Value asset class by a process that's both (a) complicated (because it requires a whole new concept and computer-driven step in calculating an SV blended rate) but (b) natural (because it accomplishes this structural repair in tandem with the underlying cash flows and involves no uncomfortable aspect of favoring one group of participants over the other). Indeed, the entire purpose of this SV Bifurcation invention is to preclude the structural favoritism that currently exists. As Bill Clark, CFO of the Federal Reserve's own benefit plans has opined, “ . . . the last thing you want as an employer is for your actives to be subsidizing your retirees.” But, this is exactly what prevails in SV currently, albeit hidden for the time being.

The SV Bifurcation innovation removes this implicit subsidy and in particular removes the pernicious effects which the current structure can be predicted to produce, when CD and similar interest rates available in the marketplace increase above SV credited rates. The overall purpose and effect of the idea is to buttress the “Stable” in “Stable Value” by preserving the competitive nature of the SV blended rate, regardless of rate increases or decreases.

As a result:
a. participants get what they expect,
b. no longer can participants subsidize (or exploit) other participants within the SV fund, (c) plan sponsors and their advisors avoid ugly surprises when rates go the wrong way, after 2.5 decades

In one embodiment of the technology described herein the process for creating a stable value bifurcation fund where the fund has a duration of x years (where x can vary between 2 and 10). The process comprises:
a. obtaining a combined stable value fund consisting of active participant accounts and inactive participant accounts;
b. dividing the combined stable value fund into an active portion comprised of active participant accounts and an inactive portion comprised of inactive participant accounts;
c. identifying, using a computer, at a duration equal to x−y, with a value of y equal to (x−n), with n having an initial value of (x−1), x−y inactive pro rata maturities and x−y active pro rata maturities in the first stable value fund;
d. creating, using a computer, an inactive stable value bifurcation fund consisting of the x−y pro rata inactive maturities and an active stable value bifurcation fund consisting of the x−y pro rata active maturities;
e. incrementing, using a computer, the value of n by 1;
f. identifying, using a computer, at a duration equal to x−y, inactive pro rata maturities and x−y active maturities in the stable value fund;
g. transferring, using a computer, the x−y pro rata inactive maturities into the inactive stable value bifurcation fund;
h. transferring, using a computer, the x−y pro rata active maturities into the active stable value bifurcation fund; and
i. repeating steps e through h, using a computer, if y≠x.

In a specific example of a 3-year fund a method for creating a stable value bifurcation fund, the method comprises:
a. acquiring a combined stable value fund consisting of active participant accounts and inactive participant accounts;
b. identifying the active participant accounts and the inactive participant accounts;
c. determining, using a computer, a blended rate for the combined stable value fund;
d. determining, using a computer, that a one year anniversary has been reached;
e. identifying, using a computer, inactive one year pro rata maturities and active one year pro rata maturities in the stable value fund;
f. creating, using a computer, an inactive stable value bifurcation fund;
g. transferring the inactive one year pro rata maturities from the combined stable value fund into the inactive stable value bifurcation fund;
h. creating, using a computer, an active stable value bifurcation fund;
i. transferring the active one year pro rata maturities from the combined stable value fund into the active stable value bifurcation fund;
j. determining, using a computer, an inactive blended rate for the inactive stable value fund;
k. determining, using a computer, an active blended rate for the active stable value fund;
l. determining, using a computer, a blended rate for the combined stable value fund based on the active participant accounts and the inactive participant accounts;
m. determining, using a computer, that a two year anniversary has been reached;
n. identifying, using a computer, inactive two year pro rata maturities and active two year pro rata maturities in the stable value fund;
o. transferring the inactive two year pro rata maturities from the combined stable value fund into the inactive stable value bifurcation fund;
p. transferring the active two year pro rata maturities from the combined stable value fund into the active stable value bifurcation fund;
q. determining, using a computer, an inactive blended rate for the inactive stable value fund;
r. determining, using a computer, an active blended rate for the active stable value fund;
s. determining, using a computer, a blended rate for the combined stable value fund based on the active participant accounts and the inactive participant accounts;
t. determining, using a computer, that a three year anniversary has been reached;
u. identifying, using a computer, inactive three year pro rata maturities and active three year pro rata maturities in the stable value fund;
v. transferring the inactive three year pro rata maturities from the combined stable value fund into the inactive stable value bifurcation fund;
w. transferring the active three year pro rata maturities from the combined stable value fund into the active stable value bifurcation fund;
x. determining, using a computer, an inactive blended rate for the inactive stable value fund; and
y. determining, using a computer, an active blended rate for the active stable value fund.

Optional Feature—ECRO (Enhanced Credited Rate Option): To reiterate, the SV Bifurcation invention is vital to the structural integrity of the SV asset class since it repairs its most glaring structural flaw: the risk of the SV Credited Rate becoming deeply uncompetitive—even potentially down to 0%—in the event of a rate increase and subsequent exercise of the “retiree put.”

Another related mechanism which works toward the same end, and can be especially useful in plan where in addition to the implicit ‘retiree put” there's also “put” aspects within the active participants in the form of after-tax monies or other potentially Credited Rate disrupting elements. This secondary rate stabilization mechanism involves using a new and sophisticated Credited Rate amortization formula as follows: Credited Rate=Current Yield plus [(MV−BV) divided by (MV×2D)]

Under currently prevailing SV amortization formulas, if the MV is 95% of BV and the portfolio's yield to maturity is 5.0% and its duration 3 years, the Credited Rate is around 3.25%. This reflects the credited rate on the SV book value at which it will converge with the market value over the duration of the portfolio, The downside is that this convergence depends upon there being no withdrawals, which is unrealistic if the Credited Rate is uncompetitive—3.25% versus prevailing market rates of 5.0%.

But if one uses the above proprietary Credited Rate formula, then that forces an asymmetrical pattern of amortization, which, especially when coupled with SV Bifurcation, helps “force” the Credited Rate from getting too out of whack with prevailing rates, thus also helping to avoid the self-fulfilling prophecy of a “death spiral.” In the above example the first year CR would be 4.12% instead of 3.25%.

Thus, when coupled with SV Bifurcation the structural integrity of the SV asset class is greatly improved in that it's uncomfortable “put” aspects where one group of participants effectively subsidizes another are either removed entirely (as in SV Bifurcation) or mitigated by the above Enhanced Credited Rate Option (ECRO).

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered.

What is claimed is:

1. A method for creating a stable value bifurcation fund, the fund having a duration of x years, the method comprising:
a. obtaining a combined stable value fund consisting of active participant accounts and inactive participant accounts;
b. dividing the combined stable value fund into an active portion comprised of active participant accounts and an inactive portion comprised of inactive participant accounts;
c. identifying, using a computer, at a duration equal to x−y, with a value of y equal to (x−n), with n having an initial value of (x−1), x−y inactive pro rata maturities and x−y active pro rata maturities in the first stable value fund;
d. creating, using a computer, an inactive stable value bifurcation fund consisting of the x−y pro rata inactive maturities and an active stable value bifurcation fund consisting of the x−y pro rata active maturities;
e. incrementing, using a computer, the value of n by 1;
f. identifying, using a computer, at a duration equal to x−y, inactive pro rata maturities and x−y active maturities in the stable value fund;
g. transferring, using a computer, the x−y pro rata inactive maturities into the inactive stable value bifurcation fund;
h. transferring, using a computer, the x−y pro rata active maturities into the active stable value bifurcation fund; and
i. repeating steps e through h, using a computer, if y#x.

2. The method for creating a stable value bifurcation fund of claim 1, wherein x=2.

3. The method for creating a stable value bifurcation fund of claim 1, wherein x=3.

4. The method for creating a stable value bifurcation fund of claim 1, wherein x=4.

5. The method for creating a stable value bifurcation fund of claim 1, wherein x=5.

6. The method for creating a stable value bifurcation fund of claim 1, wherein x=6.

7. The method for creating a stable value bifurcation fund of claim 1, wherein x=7.

8. The method for creating a stable value bifurcation fund of claim 1, wherein x=8.

9. The method for creating a stable value bifurcation fund of claim 1, wherein x=9.

10. The method for creating a stable value bifurcation fund of claim 1, wherein x=10.

11. A method for creating a stable value bifurcation fund, the fund having a duration of 3 years, the method comprising the steps of
a. acquiring a combined stable value fund consisting of active participant accounts and inactive participant accounts;
b. identifying the active participant accounts and the inactive participant accounts;
c. determining, using a computer, a blended rate for the combined stable value fund;
d. determining, using a computer, that a one year anniversary has been reached;
e. identifying, using a computer, inactive one year pro rata maturities and active one year pro rata maturities in the stable value fund;
f. creating, using a computer, an inactive stable value bifurcation fund;
g. transferring the inactive one year pro rata maturities from the combined stable value fund into the inactive stable value bifurcation fund;
h. creating, using a computer, an active stable value bifurcation fund;
i. transferring the active one year pro rata maturities from the combined stable value fund into the active stable value bifurcation fund;
j. determining, using a computer, an inactive blended rate for the inactive stable value fund;
k. determining, using a computer, an active blended rate for the active stable value fund;
l. determining, using a computer, a blended rate for the combined stable value fund based on the active participant accounts and the inactive participant accounts;
m. determining, using a computer, that a two year anniversary has been reached;
n. identifying, using a computer, inactive two year pro rata maturities and active two year pro rata maturities in the stable value fund;
o. transferring the inactive two year pro rata maturities from the combined stable value fund into the inactive stable value bifurcation fund;
p. transferring the active two year pro rata maturities from the combined stable value fund into the active stable value bifurcation fund;
q. determining, using a computer, an inactive blended rate for the inactive stable value fund;
r. determining, using a computer, an active blended rate for the active stable value fund;
s. determining, using a computer, a blended rate for the combined stable value fund based on the active participant accounts and the inactive participant accounts;
t. determining, using a computer, that a three year anniversary has been reached;
u. identifying, using a computer, inactive three year pro rata maturities and active three year pro rata maturities in the stable value fund;
v. transferring the inactive three year pro rata maturities from the combined stable value fund into the inactive stable value bifurcation fund;
w. transferring the active three year pro rata maturities from the combined stable value fund into the active stable value bifurcation fund;
x. determining, using a computer, an inactive blended rate for the inactive stable value fund; and
y. determining, using a computer, an active blended rate for the active stable value fund.
